(19) United States
(12) Patent Application Publication
(10) Pub. No.: US 2008/0194314 A1
(43) Pub. Date: Aug. 14, 2008

(54) SLOT MACHINE AND METHOD FOR CONTROLLING SLOT MACHINE

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Koto-ku (JP)

(21) Appl. No.: 12/025,388

(22) Filed: Feb. 4, 2008

(30) Foreign Application Priority Data
Feb. 5, 2007 (JP) JP2007-025684

(51) Int. Cl. A63F 13/00

(52) U.S. Cl. 463/20

(57) ABSTRACT

During execution of a slot game in which arranged symbols are rearranged, the symbols are displayed in an area used to determine whether or not a winning combination is formed. Moreover, symbols including the symbols displayed in the area used to determine whether or not a winning combination is formed are displayed in an area different from the area used to determine whether or not a winning combination is formed. When the symbols to form a winning combination are stopped and rearranged in the area used to determine whether or not a winning combination is formed, an award is provided according to bet credits.

### CROSS REFERENCE TO RELATED APPLICATION

This application is based upon and claims the benefit of priority from Japanese Patent Application No. 2007-025684 filed on Feb. 5, 2007, the entire contents of which are incorporated herein by reference.

### BACKGROUND OF THE INVENTION

1. Field of the Invention

The present invention relates to a slot machine and a method for controlling the slot machine.

2. Description of the Related Art

In a conventional slot machine, when a player inserts a predetermined number of medals into a medal insertion slot and operates a start button, a plurality of (for example, 3) reels, on which a plurality of symbols are drawn, are individually rotated. Thereafter, the reels are stopped after a lapse of predetermined time. In this event, when the symbols to form a winning combination are stopped on a preset payline or when a predetermined number of scatter symbols are stopped on a display, a payout corresponding to the number of the medals inserted is provided.

Meanwhile, the following gaming machine is described in U.S. Patent Application Laid-Open No. 2002/0025843. Specifically, in the gaming machine, a spinning reel game for simulating the rotation of a plurality of reels is displayed on one video display unit. Thereafter, when special symbols of predetermined puzzle parts are displayed, a special bonus is provided while the special symbols are displayed in an enlarged or similar manner.

### SUMMARY OF THE INVENTION

Thus, it has been desired to provide a slot machine which enables a new slot game to be played by simulating the rotation of the reels on the video display unit rather than rotating actual reels.

The present invention was made to solve the conventional problems as described above. It is an object of the present invention to provide a slot machine which can achieve further improvement in entertainment properties, and to provide a method for controlling the slot machine.

In order to achieve the foregoing object, a slot machine according to a first aspect of the present invention includes: a display configured to display a slot game in which a plurality of symbol arrays each having a predetermined number of symbols consecutively provided therein are scrolled in a loop manner and then stopped, the display including: a first display area for displaying some of the predetermined number of symbols included in each of the symbol arrays when the scrolling is stopped, and a second display area for displaying the symbols displayed in the first display area and some additional symbols among the predetermined number of symbols included in each of the symbol arrays; and a controller operable to: a) execute the slot game on the display and b) provide an award according to a combination of the symbols displayed in the first display area when the scrolling is stopped, regardless of the symbols displayed in the second display area.

According to the slot machine described above, the symbols, displayed in the first display area and more symbols than those displayed in the first display area, are displayed in the second display area. Thus, a player can proceed with the game while checking positions of the symbols in wide areas.

In the slot machine according to the first aspect, the controller may further display markers for specific symbols scrolled in the second display area, the markers indicating positions of the specific symbols, when the symbol arrays are scrolled.

According to the slot machine described above, the markers indicating the positions of the symbols are displayed for the specific symbols displayed in the second display area. Thus, the player can proceed with the game while checking movement of the symbols in wide areas.

Furthermore, in the slot machine according to the first aspect, the second display area may be set so as to display the symbols displayed in the first display area and the symbols on an upstream side of the symbols displayed in the first display area with respect to a direction of the scrolling.

According to the slot machine described above, the symbols on the upstream side of the symbols displayed in the first display area are displayed. Thus, it becomes easier for the player to estimate timing for stopping predetermined symbols in the first display area. Consequently, entertainment properties can be improved.

A slot machine according to a second aspect of the present invention includes: a display configured to display a slot game in which a plurality of symbol arrays each having a predetermined number of symbols consecutively provided therein are scrolled in a loop manner and then stopped, the display including: a first display area for displaying some of the predetermined number of symbols included in each of the symbol arrays when the scrolling is stopped, and a second display area for displaying some symbols different from those displayed in the first display area among the predetermined number of symbols included in each of the symbol arrays; and a controller operable to a) execute the slot game on the display, and b) provide an award according to a combination of the symbols displayed in the first display area when the scrolling is stopped, regardless of the symbols displayed in the second display area.

According to the slot machine described above, the symbols different from those displayed in the first display area are displayed in the second display area. Thus, the player can proceed with the game while also checking the positions of the symbols in the area other than the area used to determine whether or not to provide an award.

In the slot machine according to the second aspect, the controller may further display markers for specific symbols scrolled in the second display area, the markers indicating positions of the specific symbols, when the symbol arrays are scrolled.

According to the slot machine described above, the markers are provided and displayed for the specific symbols rearranged in the second display area. Thus, the player can proceed with the game while checking movement of the symbols in wide areas.

Furthermore, in the slot machine according to the second aspect, the second display area may be set so as to display the symbols on an upstream side of the symbols displayed in the first display area with respect to a direction of the scrolling.

According to the slot machine described above, the symbols rearranged on the upstream side of the symbols displayed in the first display area are displayed in the second display area. Thus, it becomes easier for the player to estimate timing for stopping predetermined symbols in the first display area. Consequently, entertainment properties can be improved.

A slot machine according to a third aspect of the present invention includes: first and second displays configured to display a slot game in which a plurality of symbol arrays each having a predetermined number of symbols consecutively provided therein are scrolled in a loop manner and then stopped; and a controller operable to a) execute the slot game on the first and second displays and b) provide an award according to a combination of the symbols displayed on the first display when the scrolling is stopped, regardless of the symbols displayed on the second display, wherein the first display displays some of the predetermined number of symbols included in each of the symbol arrays when the scrolling is stopped, and the second display displays at least some of the symbols not displayed on the first display among the predetermined number of symbols included in each of the symbol arrays.

According to the slot machine described above, at least the symbols not displayed on the first display among the predetermined number of symbols included in the symbol arrays are displayed on the second display. Thus, the player can proceed with the game while checking positions of the symbols in wide areas.

In the slot machine according to the third aspect, the controller may further display markers for specific symbols scrolled on the second display, the markers indicating positions of the specific symbols, when the symbol arrays are scrolled.

According to the slot machine described above, the markers are provided and displayed for the specific symbols rearranged on the second display. Thus, the player can proceed with the game while checking movement of the symbols in wide areas.

In the slot machine according to the third aspect, the second display may be set so as to display the symbols on an upstream side of the symbols displayed on the first display with respect to a direction of the scrolling.

According to the slot machine described above, the symbols rearranged on the upstream side of the symbols displayed on the first display are displayed on the second display. Thus, it becomes easier for the player to estimate timing for stopping predetermined symbols on the first display. Consequently, entertainment properties can be improved.

A method for controlling a slot machine according to a fourth aspect of the present invention includes: a) displaying, in a first display area of a display configured to display a slot game in which a plurality of symbol arrays each having a predetermined number of symbols consecutively provided therein are scrolled in a loop manner and then stopped, some of the predetermined number of symbols included in each of the symbol arrays when the scrolling is stopped; b) displaying, in a second display area of the display the symbols displayed in the first display area and some additional symbols among the predetermined number of symbols included in each of the symbol arrays; and c) executing the slot game on the display and providing an award according to a combination of the symbols displayed in the first display area when the scrolling is stopped, regardless of the symbols displayed in the second display area.

According to the controlling method described above, in the slot machine, the symbols displayed in the first display area and more symbols than those displayed in the first display area are displayed in the second display area. Thus, the player can proceed with the game while checking positions of the symbols in wide areas.

The method for controlling a slot machine, according to the fourth aspect, may further include displaying markers for specific symbols scrolled in the second display area, the markers indicating positions of the specific symbols, when the symbol arrays are scrolled.

According to the controlling method described above, the markers indicating the positions of the symbols are displayed for the specific symbols displayed in the second display area. Thus, the player can proceed with the game while checking movement of the symbols in wide areas.

In the method for controlling a slot machine, according to the fourth aspect, the second display area may be set so as to display the symbols displayed in the first display area and the symbols on an upstream side of the symbols displayed in the first display area with respect to a direction of the scrolling.

According to the controlling method described above, the symbols on the upstream side of the symbols displayed in the first display area are displayed in the second display area. Thus, it becomes easier for the player to estimate timing for stopping predetermined symbols in the first display area. Consequently, entertainment properties can be improved.

A method for controlling a slot machine according to a fifth aspect of the present invention includes: a) displaying, in a first display area of a display which configured to display a slot game in which a plurality of symbol arrays each having a predetermined number of symbols consecutively provided therein are scrolled in a loop manner and then stopped, some of the predetermined number of symbols included in each of the symbol arrays when the scrolling is stopped; b) displaying, in a second display area of the display, some symbols different from those displayed in the first display area among the predetermined number of symbols included in each of the symbol arrays; and c) executing the slot game on the display and providing an award according to a combination of the symbols displayed in the first display area when the scrolling is stopped, regardless of the symbols displayed in the second display area.

According to the controlling method described above, in the slot machine, the symbols in the area in which it is not determined whether or not a predetermined winning combination is formed are displayed in the second display area. Thus, the player can proceed with the game while checking positions of the symbols in the area other than the area used to determine whether or not a winning combination is formed.

The method for controlling a slot machine, according to the fifth aspect, may further include displaying markers for specific symbols scrolled in the second display area, the markers indicating positions of the specific symbols, when the symbol arrays are scrolled.

According to the controlling method described above, the markers are provided and displayed for the specific symbols rearranged in the second display area. Thus, the player can proceed with the game while checking movement of the symbols in wide areas.

In the method for controlling a slot machine, according to the fifth aspect, the second display area may be set so as to display the symbols on an upstream side of the symbols displayed in the first display area with respect to a direction of the scrolling.

According to the controlling method described above, the symbols rearranged on the upstream side of the symbols displayed in the first display area are displayed in the second display area. Thus, it becomes easier for the player to estimate timing for stopping predetermined symbols in the first display area. Consequently, entertainment properties can be improved.

A method for controlling a slot machine according to a sixth aspect of the present invention includes: a) displaying, on a first display configured to display a slot game in which a plurality of symbol arrays each having a predetermined number of symbols consecutively provided therein are scrolled in a loop manner and then stopped, some of the predetermined number of symbols included in the respective symbol arrays when the scrolling is stopped; b) displaying, on a second display configured to display the slot game in which the plurality of symbol arrays each having the predetermined number of symbols consecutively provided therein are scrolled in a loop manner and then stopped, at least some of the symbols not displayed on the first display among the predetermined number of symbols included in the respective symbol arrays; and c) executing the slot game on the first and second displays and providing an award according to a combination of the symbols displayed on the first display when the scrolling is stopped, regardless of the symbols displayed on the second display. According to the controlling method described above, at least the symbols not displayed on the first display among the predetermined number of symbols included in the symbol arrays are displayed on the second display. Thus, the player can proceed with the game while checking positions of the symbols in wide areas.

The method for controlling a slot machine, according to the sixth aspect, may further include displaying markers for specific symbols scrolled on the second display, the markers indicating positions of the specific symbols, when the symbol arrays are scrolled.

According to the controlling method described above, the markers are provided and displayed for the specific symbols rearranged on the second display. Thus, the player can proceed with the game while checking movement of the symbols in wide areas.

In the method for controlling a slot machine, according to the sixth aspect, the second display may be set so as to display the symbols on an upstream side of the symbols displayed on the first display with respect to a direction of the scrolling.

According to the controlling method described above, the symbols rearranged on the upstream side of the symbols displayed on the first display are displayed on the second display. Thus, it becomes easier for the player to estimate timing for stopping predetermined symbols on the first display. Consequently, entertainment properties can be improved.

### BRIEF DESCRIPTION OF THE DRAWINGS

FIG. 1 is a view showing a display example of a game displayed on a liquid crystal display in a slot machine according to an embodiment of the present invention.

FIG. 2 is a perspective view showing the slot machine according to the embodiment of the present invention.

FIG. 3 is a block diagram showing a control circuit in the slot machine according to the embodiment of the present invention.

FIG. 4 is a schematic view showing storage areas in a ROM according to the embodiment of the present invention.

FIG. 5 is a schematic view showing storage areas in a RAM according to the embodiment of the present invention.

FIG. 6 is a flowchart showing a procedure of processing executed by the slot machine according to the embodiment of the present invention.

FIG. 7 is a view showing symbols displayed in the slot machine according to the embodiment of the present invention.

FIG. 8 is a view showing a display example of a game displayed on a liquid crystal display in a slot machine according to a first modified embodiment of the present invention.

FIG. 9 is a flowchart showing a procedure of processing executed by the slot machine according to the first modified embodiment of the present invention.

FIG. 10 is a view showing symbols displayed in the slot machine according to the first modified embodiment of the present invention.

FIG. 11 is a view showing a display example of a game displayed on a liquid crystal display in a slot machine according to a second modified embodiment of the present invention.

FIG. 12 is a view showing a display example of a game displayed on an upper display in the slot machine according to the second modified embodiment of the present invention.

FIG. 13 is a block diagram showing a control circuit in the slot machine according to the second modified embodiment of the present invention.

FIG. 14 is a flowchart showing a procedure of processing executed by the slot machine according to the second modified embodiment of the present invention.

FIG. 15 is a view showing symbols displayed in the slot machine according to the second modified embodiment of the present invention.

FIG. 16 is a view showing a display example of a game displayed on the upper display in a slot machine according to a third modified embodiment of the present invention.

FIG. 17 is a flowchart showing a procedure of processing executed by the slot machine according to the third modified embodiment of the present invention.

FIG. 18 is a view showing symbols displayed in the slot machine according to the third modified embodiment of the present invention.

### DETAILED DESCRIPTION OF THE EMBODIMENT

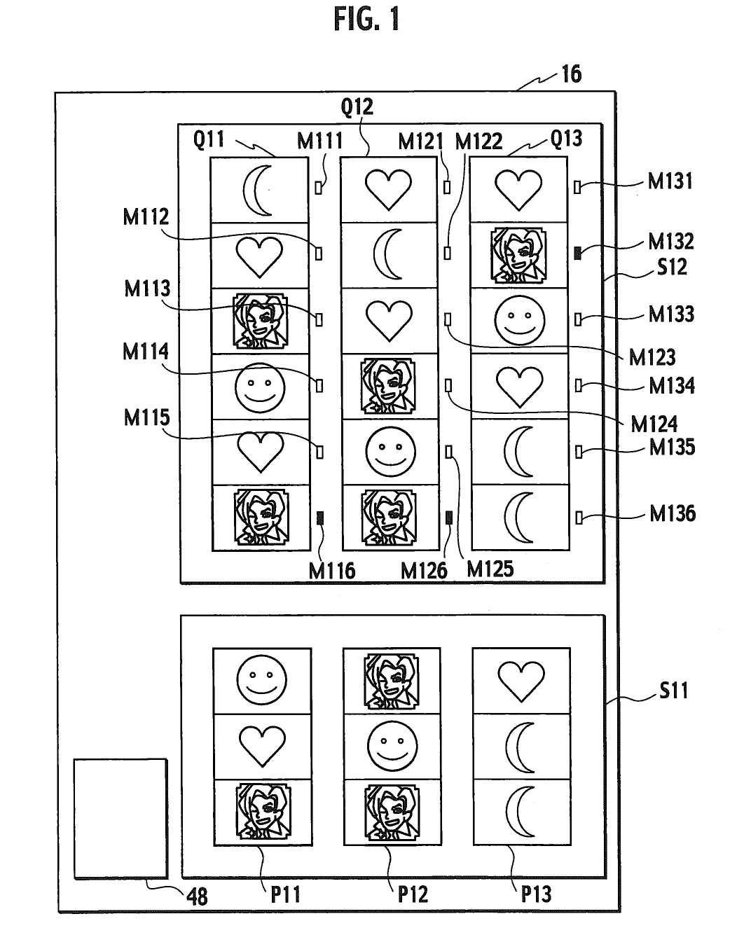

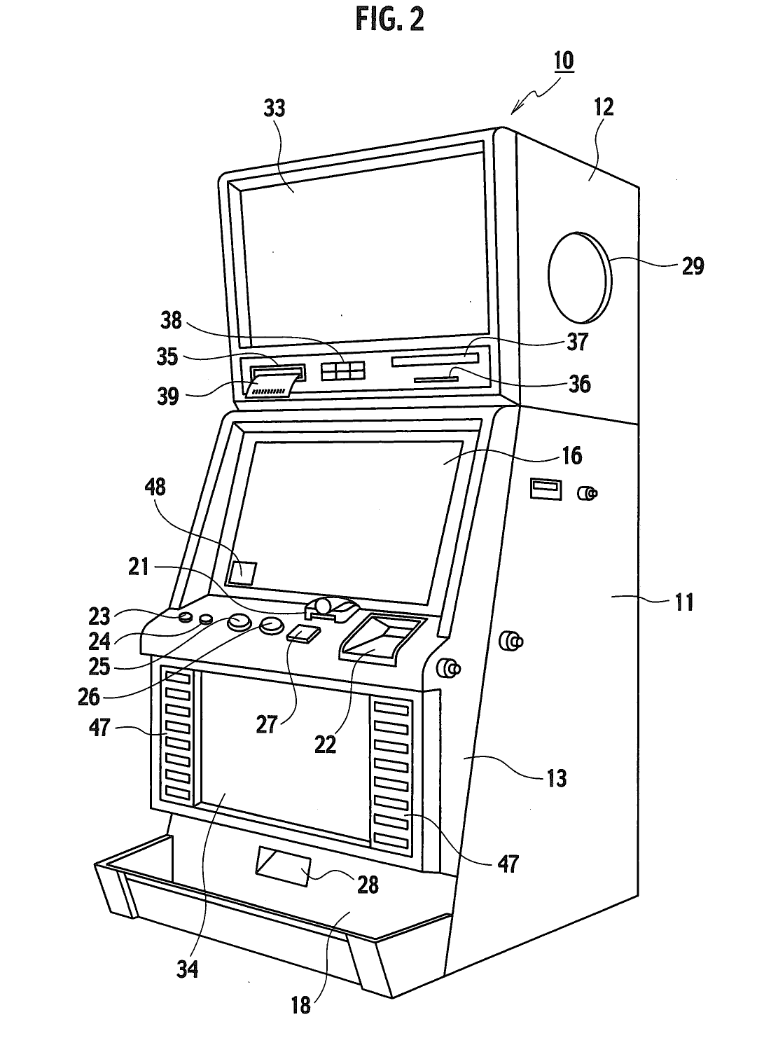

With reference to a display example shown in FIG. 1 and a perspective view of a slot machine 10 shown in FIG. 2, features of an embodiment of the present invention will be described below. FIG. 1 is an explanatory view showing a display example on a liquid crystal display (display) 16 in the slot machine 10 according to an embodiment of the present invention.

In the slot machine 10 according to this embodiment, a slot game is executed on the liquid crystal display 16. On the liquid crystal display 16, a plurality of symbol arrays (3 in the example shown in FIG. 1) including a predetermined number of symbols consecutively provided therein are scrolled in loop manner, and then stopped. The liquid crystal display 16 has first and second display areas S11 and S12 for displaying the symbols and a payout amount display area (award display area) 48 for displaying the payout amount (awards).

In the first display area S11, some of the predetermined number of symbols included in each of the symbol arrays are displayed. In the example shown in FIG. 1, the first display area S11 has symbol array display areas P11, P12 and P13. In each of the symbol array display areas, three consecutive symbols among the predetermined number of symbols consecutively provided in each of the symbol array display areas are displayed. In the first display area S11, three symbols are displayed per symbol display array for each of the three symbol arrays. Thus, a total of nine symbols are displayed in the first display area S11. When the scrolling is stopped, a payout (an award) is provided according to a combination of the symbols displayed in the first display area S11.

In the second display area S12, the symbols displayed in the first display area S11 and some additional symbols are displayed among the predetermined number of symbols included in each of the symbol arrays. In the example shown in FIG. 1, the second display area S12 has symbol array display areas Q11, Q12 and Q13. In each of the symbol array display areas, six consecutive symbols among the predetermined number of symbols consecutively provided in each of the symbol arrays are displayed. The lower three symbols among the six consecutive symbols displayed in each of the symbol arrays are the same as those displayed in the first display area S11. The lower three symbols among the symbols displayed in the symbol array display area Q11 are the same as those displayed in the symbol array display area P11. The lower three symbols among the symbols displayed in the symbol array display area Q12 are the same as those displayed in the symbol array display area P12. The lower three symbols among the symbols displayed in the symbol array display area Q13 are the same as those displayed in the symbol array display area P13.

The upper three symbols among the six consecutive symbols displayed in each of the symbol arrays are three symbols adjacently provided upstream of the symbols displayed in the first display area S11 among the plurality of symbols provided in the symbol array. Here, the upstream means a direction different from a direction in which the symbol arrays are scrolled during execution of the slot game. The symbols displayed in the symbol array display area Q11 are symbols adjacently provided on the upstream side of the symbols displayed in the symbol array display area P11. The symbols displayed in the symbol array display area Q12 are symbols adjacently provided on the upstream side of the symbols displayed in the symbol array display area P12. The symbols displayed in the symbol array display area Q13 are symbols adjacently provided on the upstream side of the symbols displayed in the symbol array display area P13. In the second display area S12, six symbols are displayed in the symbol array display area for each of the three symbol arrays. Thus, a total of eighteen symbols are displayed in the second display area S12. The display of the symbols in the second display area S12 is not associated with provision of a payout.

When the symbol arrays are scrolled, markers indicating positions of specific symbols are displayed for the respective symbols displayed in the second display area S12. For example, in the case where the markers are displayed only for joker symbols, markers M116, M126 and M132 corresponding to the jokers are lighted. Each of the markers for the symbols other than the specific symbols is not lighted or the marker itself is not displayed. When the specific symbols are moved by scrolling, positions of the lighted markers are also moved so as to follow the positions of the specific symbols moved.

As described above, in the slot machine 10 according to this embodiment, some of the symbols are displayed in the first display area S11 associated with provision of payouts and the symbols including the symbols displayed in the first display area S11 are displayed in the second display area S12 not associated with provision of payouts. Thus, a player can proceed with the game while checking the positions of the symbols in wide areas.

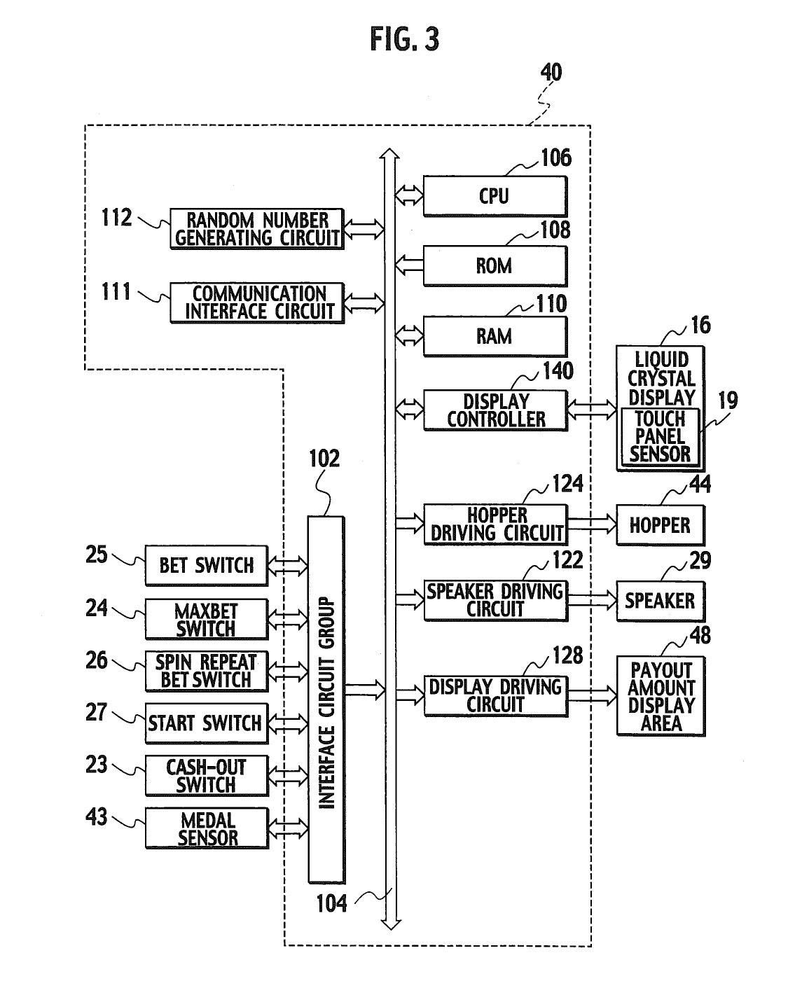

Next, detailed description will be given of a configuration of the slot machine 10 according to this embodiment. As shown in FIG. 2, the slot machine 10 according to this embodiment includes a cabinet 11, a top box 12 provided on the cabinet and a main door 13. The cabinet 11 has the liquid crystal display 16 provided on its surface facing the player. Moreover, inside the cabinet 11, various constituent members are provided, including a controller 40 (see FIG. 3) for electrically controlling the slot machine 10, a hopper 44 (see FIG. 3) and the like. The hopper 44 controls insertion, storage and payout of medals,

Moreover, in this embodiment, medals are taken as an example of game media used for executing a game. However, the game media are not limited to the medals but may include, for example, awards, coins, tokens, electronic money and electronic value information (credits) equivalent thereto.

The main door 13 is attached to the cabinet 11 so as to be openable and closable. In approximately the center of the main door 13, the liquid crystal display 16 is provided. As described later, the liquid crystal display (display) 16 displays images related to various games including a slot game. In the slot game, as shown in FIG. 1, symbols are arranged in symbol array display areas P11, P12 and P13 provided in a matrix of 3 rows×3 columns, which are provided in a first display area S11. These symbols are changed in the symbol array display areas P11, P12 and P13 and thereafter rearranged therein. Furthermore, in the slot game, symbols are arranged in symbol array display areas Q11, Q12, and Q13 provided in a 6 rows×3 columns, which are provided in a second display area S12. These symbols are changed in the symbol display areas Q11, Q12 and Q13 and thereafter rearranged therein. When the symbols are rearranged in the symbol array display areas P11, P12 and P13 provided in the matrix of the 3 rows×3 columns in the first display area S11 and the symbols form a winning combination, a predetermined number of medals are paid out.

Moreover, a payout amount display area 48 is provided in a lower left area of the liquid crystal display 16, and displays the number of medals to be paid out.

Below the liquid crystal display 16, provided are: a medal insertion slot 21 into which medals used for playing a game are inserted; and a bill validator 22 for validating whether or not bills are legitimate and for accepting the legitimate bills. Moreover, in the vicinity of the medal insertion slot 21 and the bill validator 22, various operation switches are provided.

As the operation switches, a cash-out switch 23, a MAXBET switch 24, a BET switch 25, a spin-repeat bet switch 26 and a start switch 27 are provided.

The BET switch 25 is a switch for determining the number of credits to be bet on a slot game executed on the liquid crystal display 16. Every time the BET switch 25 is pressed, a credit for 1 medal is bet.

The spin repeat bet switch 26 is a switch for executing a slot game by betting credits equal to the credits having been bet with the aforementioned BET switch 25 in the previous game.

The start switch 27 is a switch for starting a slot game on the liquid crystal display 16 after the credits are bet. When the start switch 27 is pressed after medals are inserted into the medal insertion slot 21 or credits are bet by use of the BET switch 25, the slot game is started in the first display areas S11 on the liquid crystal display 16, and symbols, which include symbols displayed in the first display area S11, are displayed in the second display area S12.

The cash-out switch 23 is a switch for paying out the inserted medals. The medals to be paid out are discharged from a medal payout opening 28 provided in a lower part of a front of the main door 13. The medals paid out are accumulated in a medal tray 18.

The MAXBET switch 24 is a switch for betting, at a time, the maximum number of credits (for example, for 30 medals) that can be bet on one game.

On a lower front surface of the main door 13, a foot display 34 is provided, on which various images related to games executed by the slot machine 10 are displayed. The images include, for example, characters of the slot machine 10 and the like.

On both sides of the foot display 34, lamps 47 are provided, which emit light based on emission patterns preset corresponding to the plays of the slot machine 10. Below the foot display 34, the medal payout opening 28 is provided.

On a front surface of the top box 12, an upper display 33 is provided. The upper display 33 includes a display panel to display, for example, the number of medals to be paid out for a combination of symbols.

Moreover, in the top box 12, a speaker 29 is provided. Below the upper display 33, a ticket printer 35, a card reader 36, a data display 37 and a keypad 38 are provided. The ticket printer 35 prints out a bar-code on a ticket, the bar-code having coded data such as the number of credits, time and date, and an identification number of the slot machine 10, and then outputs the ticket as a bar-coded ticket 39.

The player can play a game with another slot machine by allowing the slot machine to read the bar-coded ticket 39 or change the bar-coded ticket 39 for bills and the like at a predetermined place in a gaming facility (for example, a cashier in a casino).

The card reader 36 allows a smart card to be inserted thereinto, reads and writes data from and into the inserted smart card. The smart card is a card carried by the player and stores data for identifying the player, data on a history of games played by the player, and the like.

FIG. 3 is a block diagram showing an electrical configuration of the controller 40 and various devices connected to the controller 40 provided in the slot machine 10 according to this embodiment. The controller 40 in the slot machine 10 shown in FIG. 3 is a microcomputer, including an interface circuit group 102, an I/O bus 104, a CPU 106, a ROM 108, a RAM 110, a communication interface circuit 111, a random number generating circuit 112, a speaker driving circuit 122, a hopper driving circuit 124, a display driving circuit 128 and a display controller 140.

The interface circuit group 102 is connected to the I/O bus 104. The I/O bus 104 inputs and outputs a data signal or an address signal to and from the CPU 106.

The start switch 27 is connected to the interface circuit group 102. A start signal outputted from the start switch 27 is converted into a predetermined signal by the interface circuit group 102 and then transmitted to the CPU 106 through the I/O bus 104.

The BET switch 25, the MAXBET switch 24, the spin repeat bet switch 26 and the cash-out switch 23 are further connected to the interface circuit group 102. Respective switching signals outputted from those switches 25, 24, 26 and 23 are supplied to the interface circuit group 102, converted into predetermined signals by the interface circuit group 102 and then transmitted to the CPU 106 through the I/O bus 104.

In addition, a medal sensor 43 is connected to the interface circuit group 102. The medal sensor 43 is a sensor for detecting medals inserted into the medal insertion slot 21 and is provided in a medal insertion part of the medal insertion slot 21. A detection signal outputted by the medal sensor 43 is supplied to the interface circuit group 102, converted into a predetermined signal by the interface circuit group 102 and then transmitted to the CPU 106 through the I/O bus 104.

The ROM 108 storing system programs and the RAM 110 for storing various data are connected to the I/O bus 104. The random number generating circuit 112, the communication interface circuit 111, the display controller 140, the hopper driving circuit 124, the speaker driving circuit 122 and the display driving circuit 128 are further connected to the I/O bus 104.

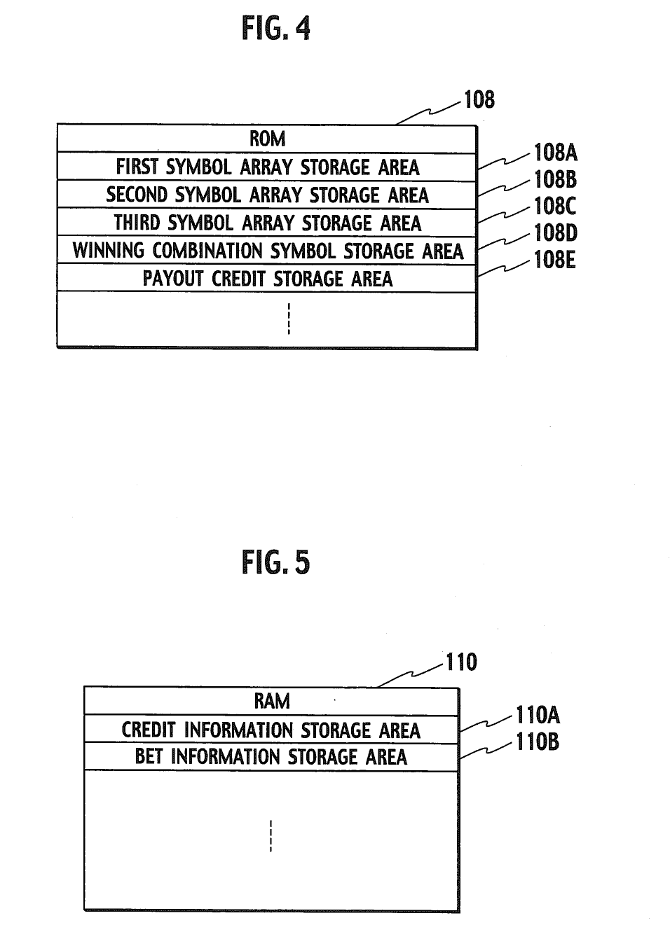

In the ROM 108, as shown in FIG. 4, a first symbol array storage area 108A, a second symbol array storage area 108B, a third symbol array storage area 108C, a winning combination symbol storage area 108D and a payout credit storage area 108E are provided besides an area for storing a system program, a game program and the like.

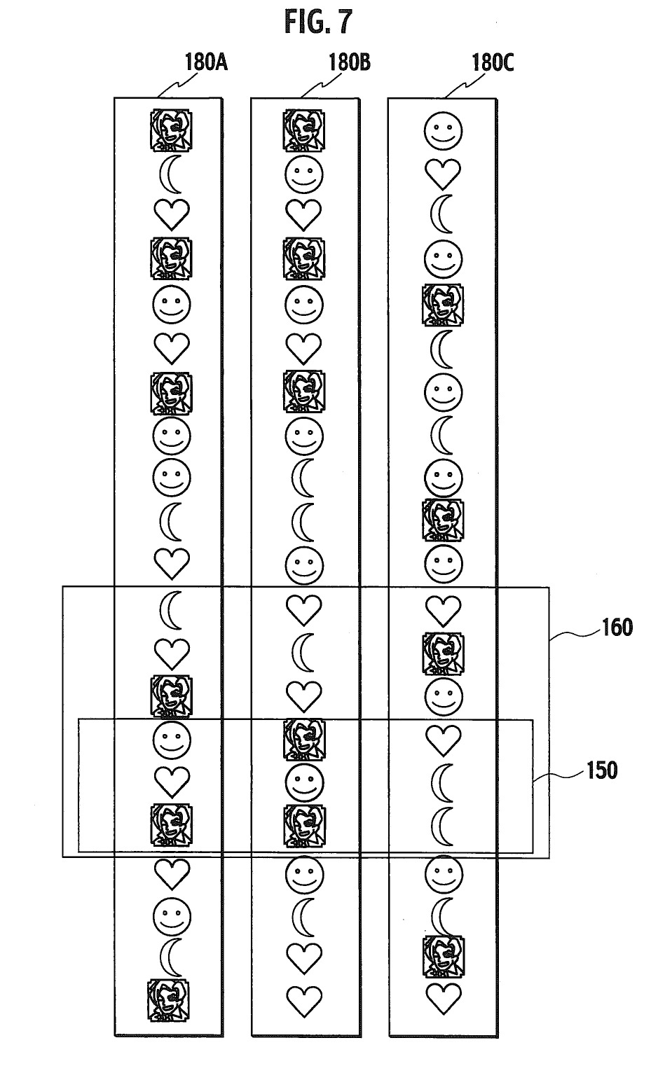

The first symbol array storage area 108A is an area in which information on a symbol group provided in a first symbol array 180A shown in FIG. 7 is stored. In this embodiment, the first symbol array 180A is the symbol group shown in FIG. 7 and is a symbol array displayed in the symbol array display areas P11 and Q11 shown in FIG. 1. In the first symbol array storage area 108A, information on symbols provided in the first symbol array 180A shown in FIG. 7 is stored so as to be associated with an order of the symbols.

The second symbol array storage area 108B is an area in which information on a symbol group provided in a second symbol array 180B shown in FIG. 7 is stored. In this embodiment, the second symbol array 180B is the symbol group shown in FIG. 7 and is a symbol array displayed in the symbol array display areas P12 and Q12 shown in FIG. 1. In the second symbol array storage area 108B, information on symbols provided in the second symbol array 180B shown in FIG. 7 is stored so as to be associated with an order of the symbols.

The third symbol array storage area 108C is an area in which information on a symbol group provided in a third symbol array 180C shown in FIG. 7 is stored. In this embodiment, the third symbol array 180C is the symbol group shown in FIG. 7 and is a symbol array displayed in the symbol array display areas P13 and Q13 shown in FIG. 1. In the third symbol array storage area 108C, information on symbols provided in the third symbol array 180C shown in FIG. 7 is stored so as to be associated with an order of the symbols.

In the winning combination symbol storage area 108D, information on arrangement of symbols to form a winning combination among arrangement of symbols displayed in a predetermined display area is stored.

In the payout credit storage area 108E, the payout amount per unit bet (for example, one credit), when a winning combination is formed in a slot game, is stored for each piece of information on winning combinations.

In the RAM 110, as shown in FIG. 5, a credit information storage area 110A and a bet information storage area 110B are provided. In the credit information storage area 110A, information on the number of credits currently owned by the player is stored. In the bet information storage area 110B, information on the number of credits bet on a currently played game by the player is stored.

Upon receipt of a game start operation by the start switch 27, the CPU 106 executes a slot game by reading a game execution program. The game execution program is a program for executing a slot game on the liquid crystal display 16 through the display controller 140.

To be more specific, the game execution program is configured to execute the slot game in the first display area S11 of the liquid crystal display 16 and configured to display symbols, which include symbols displayed in the first display area S11, on the second display area S12. Here, number of the symbols displayed in the second display area S12 is more than that of the symbols displayed in the first display area S11.

The communication interface circuit 111 is connected to a whole server and the like, and transmits to the whole server data, and the like, on a history of plays executed in the slot machine 10. Moreover, the communication interface circuit 111 receives various data transmitted from the whole server.

The random number generating circuit 112 generates a random number for determining whether or not to generate a winning combination in a slot game executed on the liquid crystal display 16.

The display driving circuit 128 performs control of displaying the number of medals to be paid out in the payout amount display area 48 set in the lower left area of the liquid crystal display 16.

The speaker driving circuit 122 outputs sound data to the speaker 29. Specifically, the CPU 106 reads sound data stored in the ROM 108 and transmits the sound data to the speaker driving circuit 122 through the I/O bus 104. Thus, predetermined sound effects are emitted from the speaker 29.

The hopper driving circuit 124 outputs a payout signal to the hopper 44 when a cash-out occurs. Specifically, when a cash-out signal is inputted by the cash-out switch 23, the CPU 106 outputs a driving signal to the hopper driving circuit 124 through the I/O bus 104. Thus, the hopper 44 pays out medals equivalent to the number of credits remaining at this time, which number is stored in a predetermined memory area of the RAM 110.

The display controller 140 performs display control for executing a slot game on the liquid crystal display 16. Specifically, the CPU 106 generates an image display command signal corresponding to a state and an outcome of a slot game, and outputs the image display command signal to the display controller 140 through the I/O bus 104. Upon receipt of the image display command signal outputted by the CPU 106, the display controller 140 generates a driving signal for driving the liquid crystal display 16 according to the image display command, and outputs the generated driving signal to the liquid crystal display 16. Thus, a predetermined image is displayed on the liquid crystal display 16.

Furthermore, on a surface of the liquid crystal display 16, the touch panel sensor 19 is provided. When the player touches the touch panel sensor 19, data of a contact location on the liquid crystal display 16 is detected and transmitted to the CPU 106.

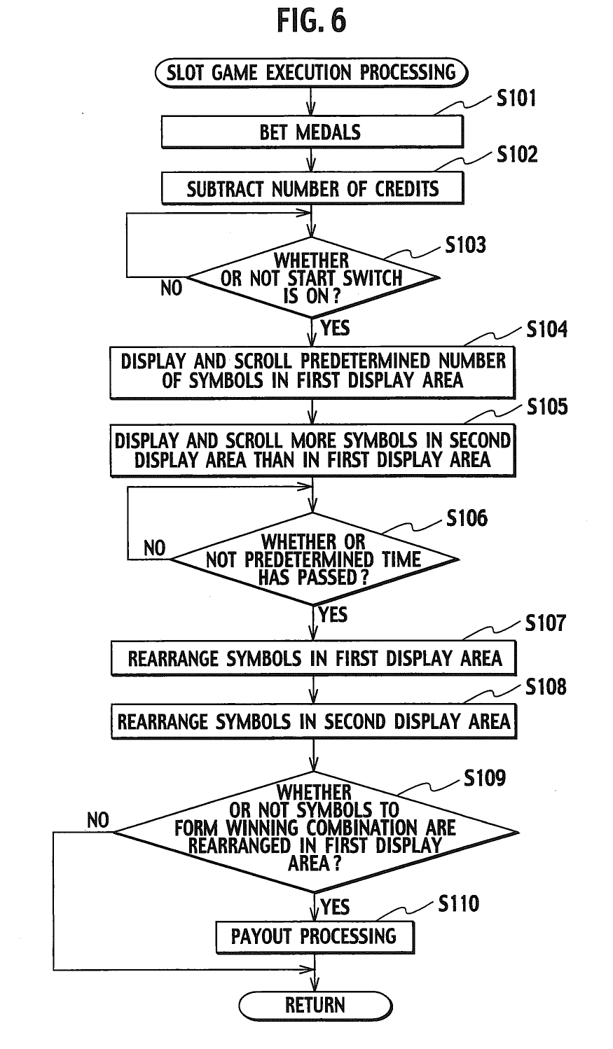

Next, with reference to a flowchart shown in FIG. 6, description will be given of slot game execution processing performed by the slot machine 10 according to this embodiment.

When medals are inserted into the medal insertion slot or a certain number of credits are bet by the player to execute a slot game (Step S101), the certain number of bet credits is subtracted from the number of credits currently held (Step S102). In this event, the number of credits bet is stored in the bet information storage area 110B in the RAM 110 and the number of credits from which the number of credits bet is subtracted is stored in the credit information storage area 110A. Thereafter, it is determined whether or not the start switch 27 is turned on. If the start switch 27 is turned on (YES in Step S103), symbols arranged in each of the symbol array display areas P11, P12 and P13 set in the first display area S11 on the liquid crystal display 16 are scrolled (Step S104). In this event, the CPU 106 displays the symbol group stored in the first symbol array storage area 108A in the ROM 108 by scrolling the symbol group in a predetermined direction in the first symbol array display area P11 in the first display area S11. Moreover, the CPU 106 displays the symbol group stored in the second symbol array storage area 108B by scrolling the symbol group in the predetermined direction in the second symbol array display area P12. Furthermore, the CPU 106 displays the symbol group stored in the third symbol array storage area 108C by scrolling the symbol group in the predetermined direction in the third symbol array display area P13. In this embodiment, as shown in FIG. 7, in a symbol group 150 displayed in the first display area S11 at a certain point in the scrolling, three symbols are displayed per array for each of the three symbol arrays. Thus, a total of nine symbols are displayed.

Furthermore, symbols arranged in each of the symbol array display areas Q11, Q12 and Q13 set in the second display area S12 on the liquid crystal display 16 are scrolled (Step S105). In this event, the CPU 106 displays more symbols than the symbols displayed in the first display area S11, while scrolling the symbols in a predetermined direction in the first symbol array display area Q11 in the second display area S12. Specifically, the CPU 106 displays the symbols including the symbols displayed in the first display area S11 and more from among the symbol groups stored in the first symbol array storage area 108A in the ROM 108. Moreover, the CPU 106 displays more symbols than the symbols displayed in the first display area S11, while scrolling the symbols in a predetermined direction in the first symbol array display area Q12 in the second display area S12. Specifically, the CPU 106 displays the symbols including the symbols displayed in the first display area S11 and more from among the symbol groups stored in the first symbol array storage area 108B in the ROM 108 Furthermore, the CPU 106 displays more symbols than the symbols displayed in the first display area S11, while scrolling the symbols in a predetermined direction in the first symbol array display area Q13 in the second display area S12. Specifically, the CPU 106 displays the symbols including the symbols displayed in the first display area S11 and more from among the symbol groups stored in the first symbol array storage area 108C in the ROM 108. In this embodiment, as shown in FIG. 7, in a symbol group 160 displayed in the second display area S12 at any time point during the scrolling, six symbols are displayed per array for each of the three symbol arrays. Thus, a total of eighteen symbols are displayed. The symbol group 160 displayed in the second display area S12 includes the symbol group 150 displayed in the first display area S11. Furthermore, in this event, when predetermined symbols are displayed, the CPU 106 lights markers corresponding to the predetermined symbols in the second display area S12. Furthermore, in this event, the CPU 106 lights the markers corresponding to the predetermined symbols along with scrolling of the predetermined symbols.

Subsequently, when a predetermined time (for example, 5 seconds) has passed since start of symbol scrolling (YES in Step S106), the CPU 106 rearranges the symbols in the symbol array display areas P11, P12 and P13 in the first display area S11 (Step S107). Furthermore, the CPU 106 rearranges the symbols in the symbol array display areas Q11, Q12 and Q13 in the second display area S12 (Step S108). In this event, the symbols rearranged in the second display area S12 include the symbols rearranged in the first display area S11 and symbols arranged on an upstream side of the symbols rearranged in the first display area S11.

Based on the information on the winning combinations stored in the winning combination symbol storage area 108C in the ROM 108, the CPU 106 determines whether or not the symbols to form a winning combination are rearranged in each of the symbol array display areas P11, P12 and P13 in the first display area S11 (Step S109). Here, the winning combination means, for example, the case where predetermined symbols are arranged on a predetermined line, such as a horizontal line and an oblique line, in each of the symbol array display areas P11, P12 and P13. Note that the winning combination is not limited to the above example but can also be a combination of a predetermined number or more of predetermined symbols arranged in each of the symbol array display areas P11, P12 and P13, for example.

If the symbols to form a winning combination are rearranged in each of the symbol array display areas P11, P12 and P13 in the first display area S11 (YES in Step S109), the CPU 106 provides a payout (an award) corresponding to the winning combination based on the information stored in the payout credit storage area 108E in the ROM 108 and the bet information storage area 110A in the RAM 110 (Step S110). Moreover, if the symbols to form a winning combination are not rearranged in each of the symbol array display areas P11, P12 and P13 in the first display area S11 (NO in Step S109), the CPU 106 provides no payout. Accordingly, one slot game is finished and the processing returns to Step S101.

In the slot machine according to this embodiment as described above, the symbols are displayed in the first display area S11 used to determine whether or not a winning combination is formed, while the symbols displayed in the first display area S11 and the symbols provided upstream of the symbols displayed in the first display area S11 are displayed in the second display area S12 not used to determine whether or not a winning combination is formed. Thus, it becomes easier to set timing for stopping desired symbols at desired positions. Consequently, it becomes easier for a user to stop symbols in a combination of symbols to form a winning combination.

Furthermore, in this embodiment, markers corresponding to specific symbols are moved along with scrolling of the symbols in the second display area S12. Thus, it becomes easier to set timing for stopping the specific symbols at desired positions.

### First Modified Embodiment

In the slot machine according to the embodiment of the present invention, the description was given of the case where, when the scrolling is stopped, some of the predetermined number of symbols included in the symbol arrays are displayed in the first display area S11 on the liquid crystal display 16 and among the predetermined number of symbols included in the symbol arrays, the symbols, displayed in the first display area S11 and some additional symbols than those displayed in the first display area S11, are displayed in the second display area S12 on the liquid crystal display 16.

In a slot machine according to a first modified embodiment of the present invention, description will be given of the case where, when scrolling is stopped, some of a predetermined number of symbols included in symbol arrays are displayed in a first display area S21 on a liquid crystal display 16 and, among the predetermined number of symbols included in the symbol arrays, some symbols different from those displayed in the first display area S21 are displayed in a second display area S22 on the liquid crystal display 16.

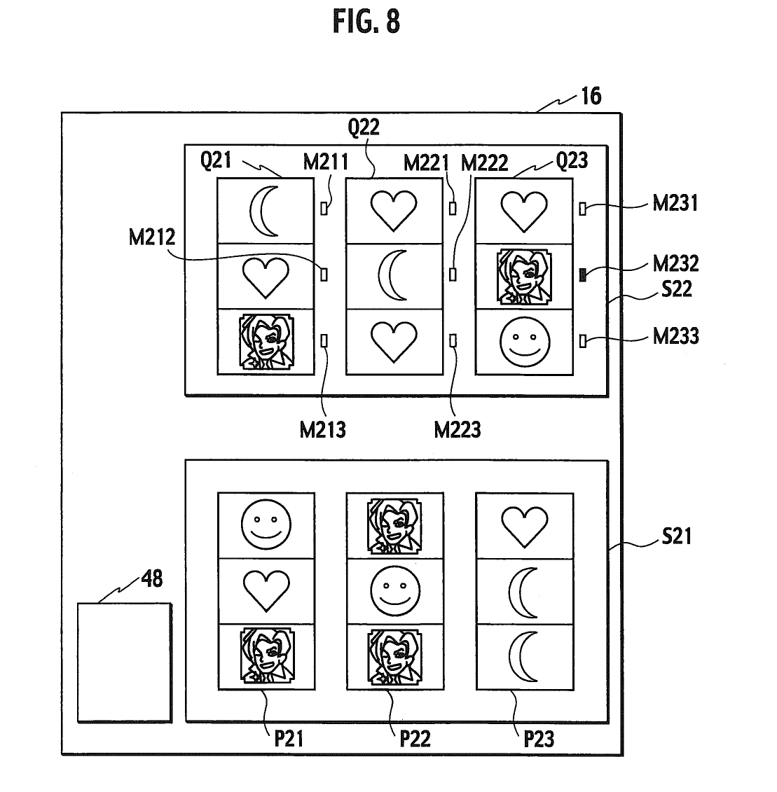

With reference to a display example shown in FIG. 8, features of a first modified embodiment of the present invention will be described below. FIG. 8 is an explanatory view showing a display example on the liquid crystal display (display) 16 in the slot machine 10 according to the first modified embodiment of the present invention.

In the slot machine 10 according to this embodiment, a slot game is executed on the liquid crystal display 16. On the liquid crystal display 16, a plurality of symbol arrays (3 in the example shown in FIG. 8) each of which includes a predetermined number of symbols consecutively provided therein are scrolled in a loop manner and then stopped. The liquid crystal display 16 has the first and second display areas S21 and S22 for displaying the symbols and a payout amount display area 48 for displaying the payout amount (awards).

In the first display area S21, symbols are displayed in the same manner as those displayed in the first display area S11 described in the embodiment of the present invention with reference to FIG. 1. The first display area S21 has symbol array display areas P21, P22 and P23. In each of the symbol array display areas P21, P22 and P23, three symbols are displayed.

In the second display area S22, symbols different from those displayed in the first display area S21 among the predetermined number of symbols included in each of the symbol arrays are displayed. In the example shown in FIG. 8, the second display area S22 has symbol array display areas Q21, Q22 and Q23. In each of the symbol array display areas, three consecutive symbols are displayed among the predetermined number of symbols consecutively provided in each of the symbol arrays. The three consecutive symbols displayed in each of the symbol arrays are three symbols adjacently provided on an upstream side of the symbols displayed in the first display area S21. The symbols displayed in the symbol array Q21 are symbols adjacently provided on the upstream side of the symbols displayed in the symbol array P21. The symbols displayed in the symbol array display area Q22 are symbols adjacently provided on the upstream side of the symbols displayed in the symbol array display area P22. The symbols displayed in the symbol array display area Q23 are symbols adjacently provided on the upstream side of the symbols displayed in the symbol array display area P23. In the second display area S22, three symbols are displayed per symbol array display area for each of the three symbol arrays. Thus, a total of nine symbols are displayed in the second display area S22. The display of the symbols in the second display area S22 is not associated with provision of a payout.

When the symbol arrays are scrolled, markers indicating positions of specific symbols are displayed for the respective symbols displayed in the second display area S22. For example, in the case where the markers are displayed only for joker symbols, markers M213 and M232 corresponding to the jokers are lighted. Each of the markers for the symbols other than the specific symbols is not lighted or the marker itself is not displayed. When the specific symbols are moved by scrolling, positions of the lighted markers are also moved so as to follow the positions of the specific symbols moved.

As described above, in the slot machine 10 according to the first modified embodiment of the present invention, some of the symbols are displayed in the first display area S21 associated with provision of payouts and the symbols adjacent to the symbols displayed in the first display area S21 are displayed in the second display area S22 not associated with provision of payouts. Thus, a player can proceed with the game while checking the positions of the symbols in wide areas.

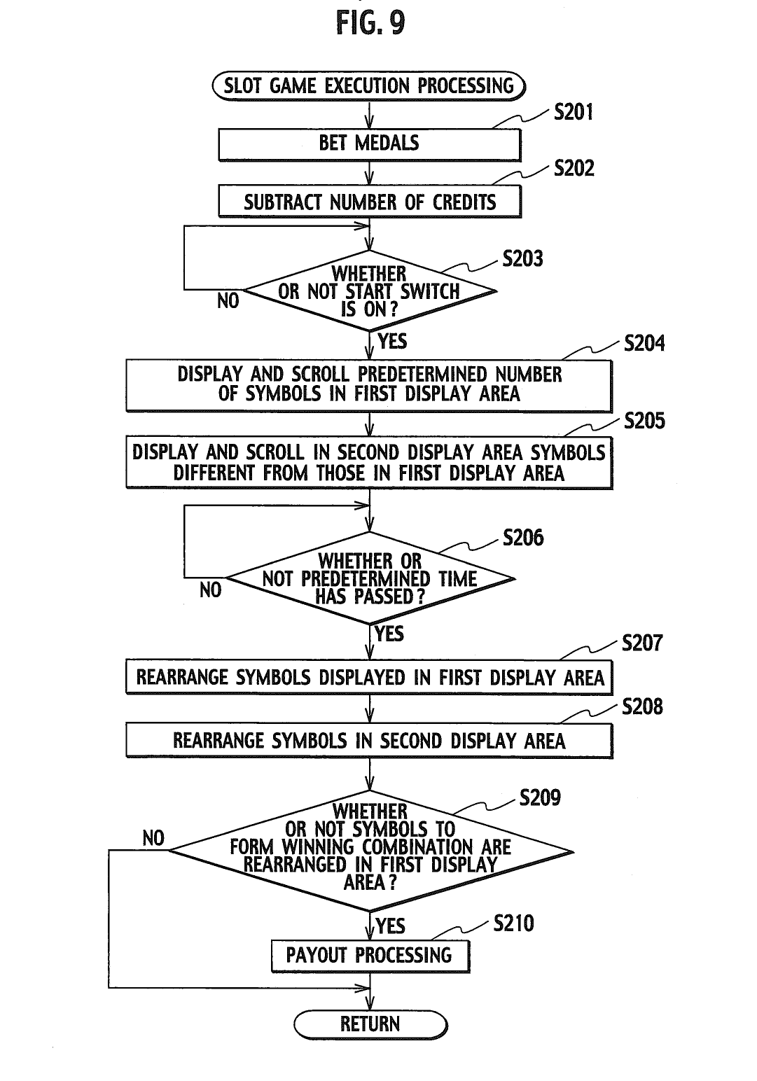

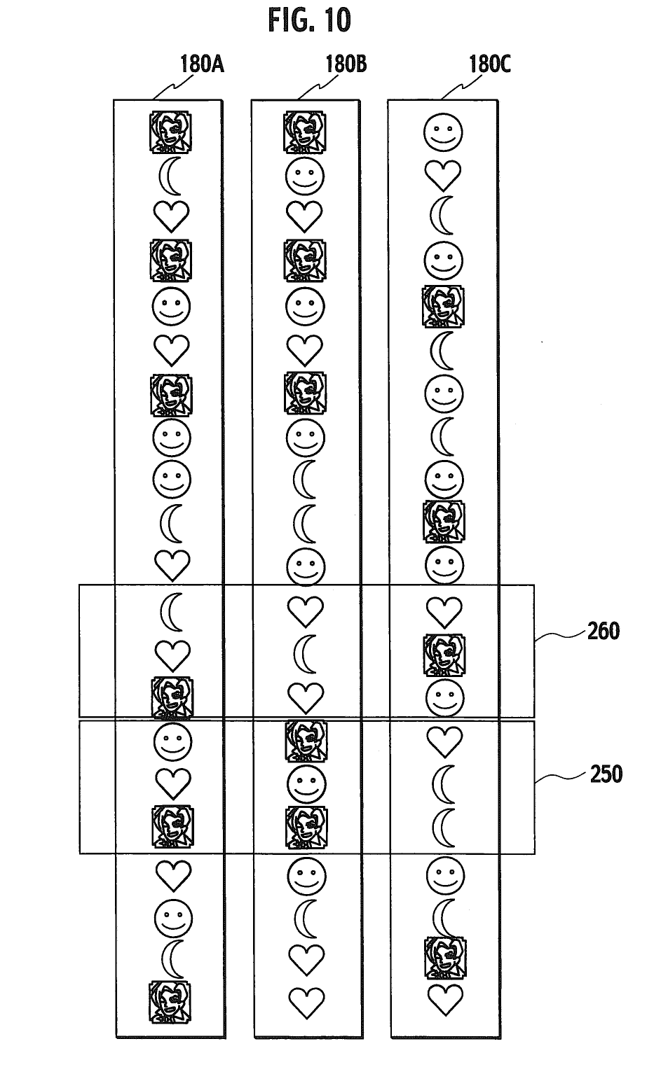

Next, with reference to a flowchart shown in FIG. 9, description will be given of slot game execution processing performed by the slot machine 10 according to the first modified embodiment of the present invention.

When medals are inserted into the medal insertion slot or a certain number of credits are bet by the player to execute a slot game (Step S201), the certain number of bet credits is subtracted from the number of credits currently held (Step S202). In this event, the number of credits bet is stored in the bet information storage area 110B in the RAM 110 and the number of credits from which the number of credits bet is subtracted is stored in the credit information storage area 110A. Thereafter, it is determined whether or not the start switch 27 is turned on. If the start switch 27 is turned on (YES in Step S203), symbols arranged in each of the symbol array display areas P21, P22 and P23 set in the first display area S21 on the liquid crystal display 16 are scrolled (Step S204). In this event, the CPU 106 displays the symbol group stored in the first symbol array storage area 108A in the ROM 108 by scrolling the symbol group in a predetermined direction in the first symbol array display area P21 in the first display area S21. Moreover, the CPU 106 displays the symbol group stored in the second symbol array storage area 108B by scrolling the symbol group in the predetermined direction in the second symbol array display area P22. Furthermore, the CPU 106 displays the symbol group stored in the third symbol array storage area 108C by scrolling the symbol group in the predetermined direction in the third symbol array display area P23. In this modified embodiment, as shown in FIG. 10, in a symbol group 250 displayed in the first display area S21 at a certain point in the scrolling, three symbols are displayed per array for each of the three symbol arrays. Thus, a total of nine symbols are displayed.

Furthermore, symbols arranged in each of the symbol array display areas Q21, Q22 and Q23 set in the second display area S22 on the liquid crystal display 16 are scrolled (Step S205). In this event, the CPU 106 displays symbols provided adjacent to the symbols displayed in the first display area S21, while scrolling the symbols in a predetermined direction in the first symbol array display area Q21 in the second display area S22. Specifically, the CPU 106 displays the symbols including the symbols displayed in the first display area S21 and more from among the symbol groups stored in the first symbol array storage area 108A in the ROM 108. Moreover, the CPU 106 displays symbols provided adjacent to the symbols displayed in the first display area S21. Furthermore, the CPU 106 displays symbols provided adjacent to the symbols displayed in the first display area S21 while scrolling the symbols in a predetermined direction in the first symbol array display area Q23 in the second display area S22. Specifically, the CPU 106 displays the symbols including the symbols displayed in the first display area S21 and more from among the symbol groups stored in the first symbol array storage area 108C in the ROM 108. In this embodiment, as shown in FIG. 10, in a symbol group 260 displayed in the second display area S22 at a certain point in the scrolling, three symbols are displayed per array for each of the three symbol arrays. Thus, a total of nine symbols are displayed. The symbol group 260 displayed in the second display area S22 includes symbols adjacent to the symbol group 250 displayed in the first display area S21. Furthermore, in this event, when predetermined symbols are scrolled, the CPU 106 lights markers corresponding to the predetermined symbols in the second display area S22. Furthermore, in this event, the CPU 106 lights the markers corresponding to the predetermined symbols along with scrolling of the predetermined symbols.

Subsequently, when a predetermined time (for example, 5 seconds) has passed since start of symbol scrolling (YES in Step S206), the CPU 106 rearranges the symbols in the symbol array display areas P21, P22 and P23 in the first display area S21 (Step S207). Furthermore, the CPU 106 rearranges the symbols in the symbol array display areas Q21, Q22 and Q23 in the second display area S22 (Step S208). In this event, the symbols rearranged in the second display area S22 are symbols adjacently provided on an upstream side of the symbols rearranged in the first display area S21.

Based on the information on the winning combinations stored in the winning combination symbol storage area 108C in the ROM 108, the CPU 106 determines whether or not the symbols to form a winning combination are rearranged in each of the symbol array display areas P21, P22 and P23 in the first display area S21 (Step S209).

If the symbols to form a winning combination are rearranged in each of the symbol array display areas P21, P22 and P23 in the first display area S21 (YES in Step S209), the CPU 106 provides a payout (an award) corresponding to the winning combination based on the information stored in the payout credit storage area 108E in the ROM 108 and the bet information storage area 110A in the RAM 110 (Step S210). Moreover, if the symbols to form a winning combination are not rearranged in each of the symbol array display areas P21, P22 and P23 in the first display area S21 (NO in Step S209), the CPU 106 provides no payout. Accordingly, one slot game is finished and the processing returns to Step S201.

In the slot machine according to the first modified embodiment as described above, the symbols are displayed in the first display area S21 used to determine whether or not a winning combination is formed, while the symbols displayed in the first display area S21 and the symbols provided upstream of the symbols displayed in the first display area S21 are displayed in the second display area S22 not used to determine whether or not a winning combination is formed. Thus, it becomes easier to set timing for stopping desired symbols at desired positions. Consequently, it becomes easier for a user to stop symbols in a combination of symbols to form a winning combination.

Furthermore, in this modified embodiment, markers corresponding to specific symbols are moved along with scrolling of the symbols in the second display area. Thus, it becomes easier to set timing for stopping the specific symbols at desired positions.

### Second Modified Embodiment

In a slot machine according to a second modified embodiment of the present invention, description will be given of the case where, when scrolling is stopped, among the predetermined number of symbols included in the symbol arrays, the symbols, displayed in the first display area S31 and some additional symbols than those displayed in the first display area S31 are displayed in a second display area S32 on an upper display 33.

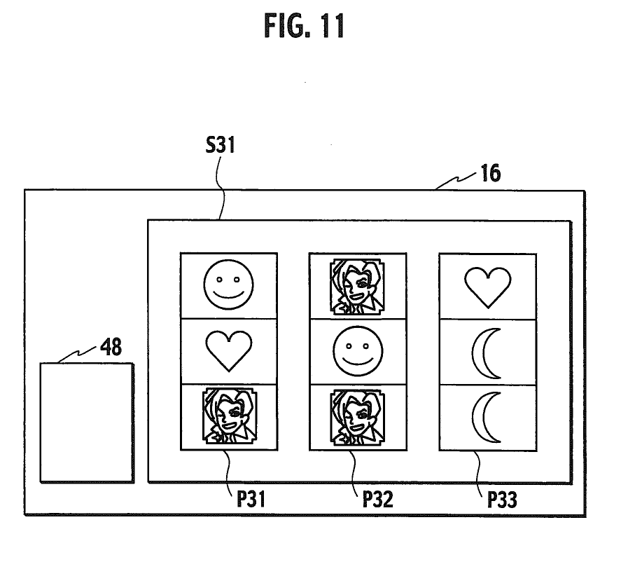

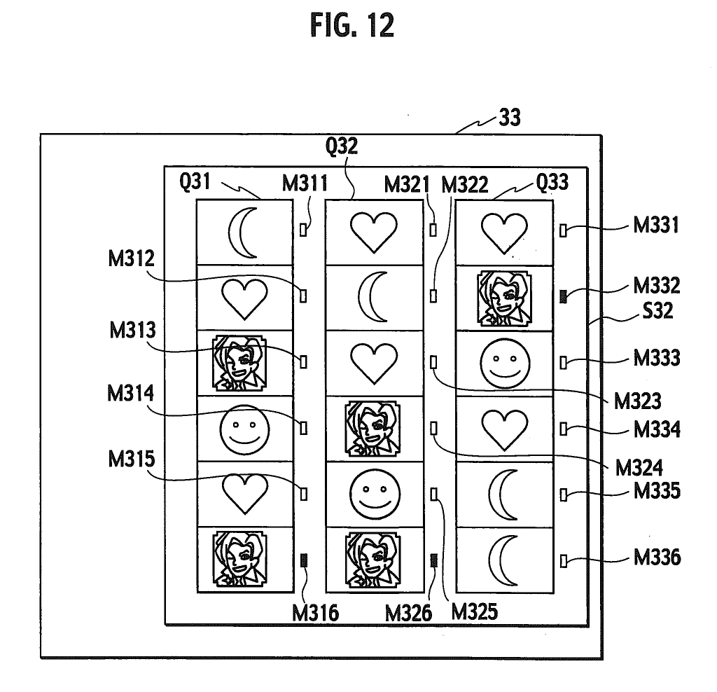

With reference to display examples shown in FIGS. 11 and 12, features of the second modified embodiment of the present invention will be described below. FIG. 11 is an explanatory view showing a display example on the liquid crystal display (first display) 16 in the slot machine 10 according to the second modified embodiment of the present invention. FIG. 12 is an explanatory view showing a display example on the upper display (second display) 33 in the slot machine 10 according to the second modified embodiment of the present invention.

In the slot machine 10 according to this modified embodiment, a slot game is executed on the liquid crystal display 16. On the liquid crystal display 16, a plurality of symbol arrays (3 in the example shown in FIG. 11) each of which includes a predetermined number of symbols consecutively provided therein are scrolled in a loop manner and then stopped. The liquid crystal display 16 has the first display area S31 for displaying the symbols and a payout amount display region 48 for displaying the payout amount.

In the first display area S31, symbols are displayed in the same manner as those displayed in the first display area S11 described in the embodiment of the present invention with reference to FIG. 1. The first display area S31 has symbol array display areas P31, P32 and P33. In each of the symbol array display areas P31, P32 and P33, three symbols are displayed.

On the upper display 33, a plurality of symbol arrays (3 in the example shown in FIG. 12) each of which includes a predetermined number of symbols consecutively provided therein are scrolled in a loop manner and then stopped. The upper display 33 has a second display area S32 for displaying the symbols.

In the second display area S32, the symbols displayed in the first display area S31 and some additional symbols displayed in the first display area S31 and symbols are displayed among the predetermined number of symbols included in each of the symbol arrays. In the example shown in FIG. 12, the second display area S32 has symbol array display areas Q31, Q32 and Q33. In each of the symbol display arrays, six consecutive symbols among the predetermined number of symbols consecutively provided in each of the symbol arrays are displayed. The lower three symbols among the six consecutive symbols displayed in each of the symbol arrays are the same as those displayed in the first display area S31. The lower three symbols among the symbols displayed in the symbol array display area Q31 are the same as those displayed in the symbol array display area P31. The lower three symbols among the symbols displayed in the symbol array display area Q32 are the same as those displayed in the symbol array display area P32. The lower three symbols among the symbols displayed in the symbol array display area Q33 are the same as those displayed in the symbol array display area P33.

The upper three symbols among the six consecutive symbols displayed in each of the symbol arrays are three symbols adjacently provided upstream of the symbols displayed in the first display area S31 among the plurality of symbols provided in the symbol array. The upper three symbols among those displayed in the symbol array display area Q31 are symbols adjacently provided on the upstream side of the symbols displayed in the symbol array display area P31. The upper three symbols among those displayed in the symbol array display area Q32 are symbols adjacently provided on the upstream side of the symbols displayed in the symbol array display area P32. The upper three symbols among those displayed in the symbol array display area Q33 are symbols adjacently provided on the upstream side of the symbols displayed in the symbol array display area P33. In the second display area S32, six symbols are displayed in the symbol display array for each of the three symbol arrays. Thus, a total of eighteen symbols are displayed in the second display area S32. The display of the symbols in the second display area S32 is not associated with provision of a payout.

When the symbol arrays are scrolled, markers indicating positions of specific symbols are displayed for the respective symbols displayed in the second display area S32. For example, in the case where the markers are displayed only for joker symbols, markers M316, M326 and M332 corresponding to the jokers are lighted. Each of the markers for the symbols other than the specific symbols is not lighted or the marker itself is not displayed. When the specific symbols are moved by scrolling, positions of the lighted markers are also moved so as to follow the positions of the specific symbols moved.

As described above, in the slot machine 10 according to this modified embodiment, some of the symbols are displayed in the first display area S31 associated with provision of payouts and the symbols including those displayed in the first display area S31 are displayed in the second display area S32 not associated with provision of payouts. Thus, a player can proceed with the game while checking the positions of the symbols in wide areas.

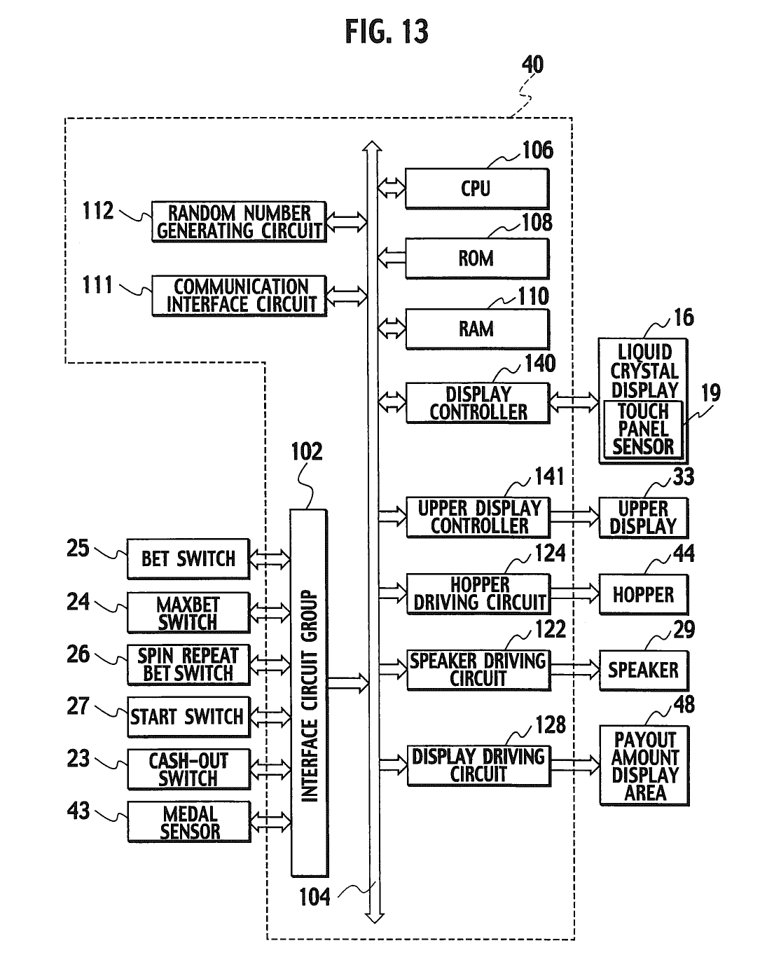

Next, a configuration of the slot machine 10 according to the second modified embodiment of the present invention will be described in detail. As shown in FIG. 13, the slot machine 10 according to the second modified embodiment of the present invention is different from the slot machine 10 according to the embodiment of the present invention described with reference to FIG. 3 in that the slot machine according to the second modified embodiment includes an upper display controller 141.

The upper display controller 141 performs display control associated with slot game execution on the upper display 33. Specifically, the CPU 106 generates an image display command signal corresponding to a state and an outcome of a slot game and outputs the image display command signal to the display controller 141 through the I/O bus 104. Upon receipt of the image display command signal outputted by the CPU 106, the upper display controller 141 generates a driving signal for driving the upper display 33 based on the image display command and outputs the generated driving signal to the upper display 33. Thus, a predetermined image is displayed on the upper display 33.

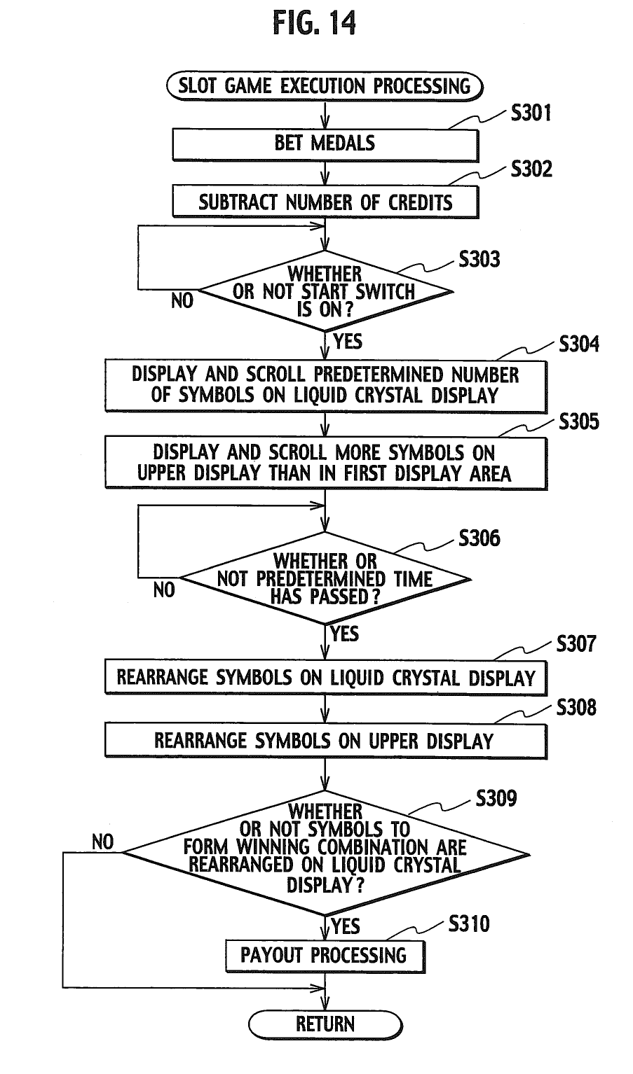

Next, with reference to a flowchart shown in FIG. 14, description will be given of slot game execution processing performed by the slot machine 10 according to the second modified embodiment of the present invention.

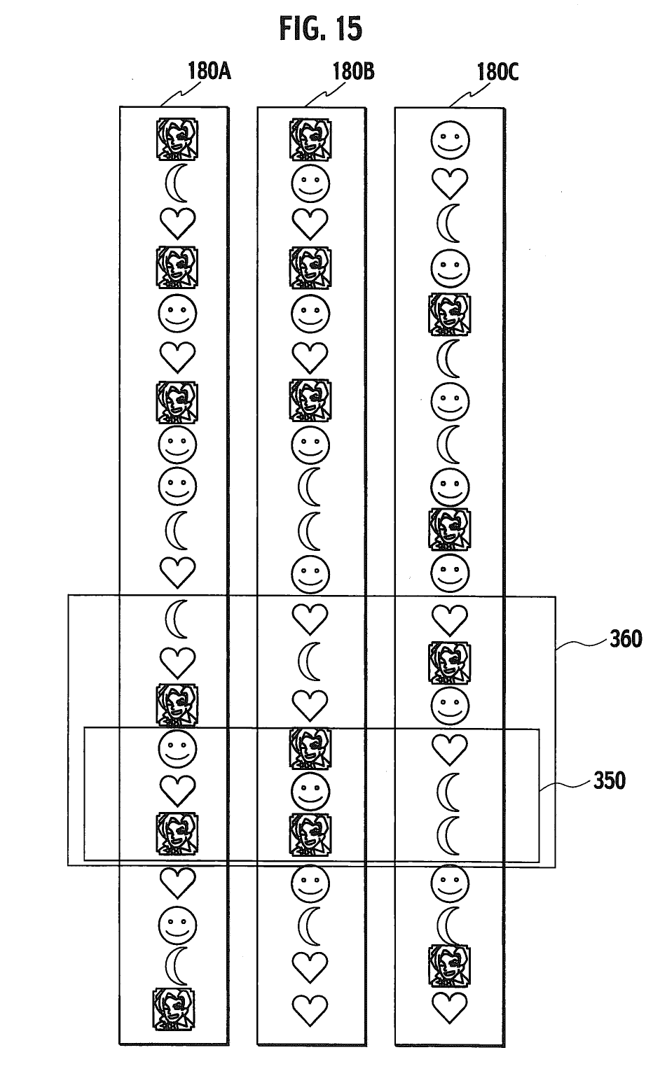

When medals are inserted into the medal insertion slot or a certain number of credits are bet by the player to execute a slot game (Step S301), the certain number of bet credits is subtracted from the number of credits currently held (Step S302). In this event, the number of credits bet is stored in the bet information storage area 110B in the RAM 110 and the number of credits from which the number of credits bet is subtracted is stored in the credit information storage area 110A. Thereafter, it is determined whether or not the start switch 27 is turned on. If the start switch 27 is turned on (YES in Step S303), symbols arranged in each of the symbol array display areas P31, P32 and P33 set in the first display area S31 on the liquid crystal display 16 are scrolled (Step S304). In this event, the CPU 106 displays the symbol group stored in the first symbol array storage area 108A in the ROM 108 by scrolling the symbol group in a predetermined direction in the first symbol array display area P31 in the first display area S31. Moreover, the CPU 106 displays the symbol group stored in the second symbol array storage area 108B by scrolling the symbol group in the predetermined direction in the second symbol array display area P32. Furthermore, the CPU 106 displays the symbol group stored in the third symbol array storage area 108C by scrolling the symbol group in the predetermined direction in the third symbol array display area P33. In the second modified embodiment of the present invention, as shown in FIG. 15, in a symbol group 350 displayed in the first display area S31 at a certain point in the scrolling, three symbols are displayed per array for each of the three symbol arrays. Thus, a total of nine symbols are displayed.

Furthermore, symbols arranged in each of the symbol display areas Q31, Q32 and Q33 set in the second display area S32 on the upper display 33 are scrolled (Step S305). In this event, the CPU 106 displays more symbols than the symbols displayed in the first display area S31, while scrolling the symbols in a predetermined direction in the first symbol array display area Q31 in the second display area S32. Specifically, the CPU 106 displays the symbols including the symbols displayed in the first display area S31 and more from among the symbol groups stored in the first symbol array storage area 108A in the ROM 108. Moreover, the CPU 106 displays more symbols than the symbols displayed in the first display area S31, while scrolling the symbols in a predetermined direction in the first symbol array display area Q31 in the second display area S32. Specifically, the CPU 106 displays the symbols including the symbols displayed in the first display area S31 and more from among the symbol groups stored in the first symbol array storage area 108B in the ROM 108. Furthermore, the CPU 106 displays more symbols than the symbols displayed in the first display area S31, while scrolling the symbols in a predetermined direction in the first symbol array display area Q31 in the second display area S32. Specifically, the CPU 106 displays the symbols including the symbols displayed in the first display area S31 and more from among the symbol groups stored in the first symbol array storage area 108C in the ROM 108. In the second modified embodiment of the present invention, as shown in FIG. 15, in a symbol group 360 displayed in the second display area S32 at a certain point in the scrolling, six symbols are displayed per array for each of the three symbol arrays. Thus, a total of eighteen symbols are displayed. The symbol group 360 displayed in the second display area S32 includes the symbol group 350 displayed in the first display area S31. Furthermore, in this event, when predetermined symbols are scrolled, the CPU 106 lights markers corresponding to the predetermined symbols in the second display area S32. Furthermore, in this event, the CPU 106 lights the markers corresponding to the predetermined symbols along with scrolling of the predetermined symbols.

Subsequently, when a predetermined time (for example, 5 seconds) has passed since start of symbol scrolling (YES in Step S306), the CPU 106 rearranges the symbols in the symbol array display areas P31, P32 and P33 in the first display area S31 (Step S307). Furthermore, the CPU 106 rearranges the symbols in the symbol array display areas Q31, Q32 and Q33 in the second display area S32 (Step S308). In this event, the symbols rearranged in the second display area S32 include the symbols rearranged in the first display area S31 and symbols provided on an upstream side of the symbols rearranged in the first display area S31.

Based on the information on the winning combinations stored in the winning combination symbol storage area 108C in the ROM 108, the CPU 106 determines whether or not the symbols to form a winning combination are rearranged in each of the symbol array display areas P31, P32 and P33 in the first display area S31 (Step S309).

If the symbols to form a winning combination are rearranged in each of the symbol array display areas P31, P32 and P33 in the first display area S31 (YES in Step S309), the CPU 106 provides a payout (an award) corresponding to the winning combination based on the information stored in the payout credit storage area 108E in the ROM 108 and the bet information storage area 110A in the RAM 110 (Step S310). Moreover, if the symbols to form a winning combination are not rearranged in each of the symbol array display areas P31, P32 and P33 in the first display area S31 (NO in Step S309), the CPU 106 provides no payout. Accordingly, one slot game is finished and the processing returns to Step S301.

In the slot machine according to the second modified embodiment of the present invention as described above, the symbols are displayed in the first display area S31 on the liquid crystal display 16 in which it is determined whether or not a winning combination is formed and the symbols provided on the upstream side of the symbols displayed in the first display area S31, the symbols including those displayed in the first display area S31, are displayed in the second display area S32 on the upper display 33 in which it is not determined whether or not a winning combination is formed. Thus, it becomes easier to set timing for stopping desired symbols at desired positions. Consequently, it becomes easier for a user to stop symbols in a combination of symbols to form a winning combination.

Furthermore, in the second modified embodiment of the present invention, markers corresponding to specific symbols are moved along with scrolling of the symbols in the second display area S32. Thus, it becomes easier to set timing for stopping the specific symbols at desired positions.

### Third Modified Embodiment

In a slot machine according to a third modified embodiment of the present invention, description will be given of the case where, when scrolling is stopped, some of a predetermined number of symbols included in symbol arrays are displayed in a first display area S31 on a liquid crystal display 16 and, among the predetermined number of symbols included in the symbol arrays, some symbols different from those displayed in the first display area S31 are displayed in a second display area S42 on an upper display 33.

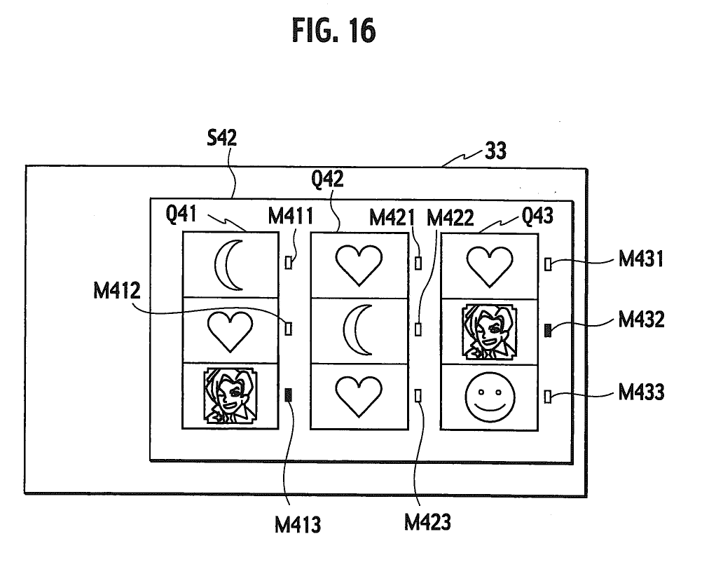

With reference to display examples shown in FIGS. 11 and 16, features of the third modified embodiment of the present invention will be described below. FIG. 11 is an explanatory view showing a display example on the liquid crystal display (display) 16 in the slot machine 10 according to the third modified embodiment of the present invention. The display example shown in FIG. 11 is as described in the second modified embodiment described above.

FIG. 16 is an explanatory view showing a display example on the upper display 33 in the slot machine 10 according to the third modified embodiment of the present invention.

In the second display area S42 on the upper display 33, symbols different from those displayed in the first display area S31 among the predetermined number of symbols included in each of the symbol arrays are displayed. In the example shown in FIG. 16, the second display area S42 has symbol array display areas Q41, Q42 and Q43. In each of the symbol array display areas, three consecutive symbols among the predetermined number of symbols consecutively provided in each of the symbol arrays are displayed. The three consecutive symbols displayed in each of the symbol arrays are three symbols adjacently provided on an upstream side of the symbols displayed in the first display area S31. The symbols displayed in the symbol array display area Q41 are symbols adjacently provided on the upstream side of the symbols displayed in the symbol array display area P31. The symbols displayed in the symbol array display area Q42 are symbols adjacently provided on the upstream side of the symbols displayed in the symbol array display area P32. The symbols displayed in the symbol array display area Q43 are symbols adjacently provided on the upstream side of the symbols displayed in the symbol array display area P33. In the second display area S42, three symbols are displayed per symbol display array for each of the three symbol arrays. Thus, a total of nine symbols are displayed in the second display area S42. The display of the symbols in the second display area S42 is not associated with provision of a payout.

When the symbol arrays are scrolled, markers indicating positions of specific symbols are displayed for the respective symbols displayed in the second display area S42. For example, in the case where the markers are displayed only for joker symbols, markers M413 and M432 corresponding to the jokers are lighted. Each of the markers for the symbols other than the specific symbols is not lighted or the marker itself is not displayed. When the specific symbols are moved by scrolling, positions of the lighted markers are also moved so as to follow the positions of the specific symbols moved.

As described above, in the slot machine 10 according to the third modified embodiment of the present invention, some of the symbols are displayed in the first display area S31 on the liquid crystal display associated with provision of payouts and the symbols adjacent to the symbols displayed in the first display area S31 are displayed in the second display area S42 on the upper display not associated with provision of payouts. Thus, a player can proceed with the game while checking the positions of the symbols in wide areas.

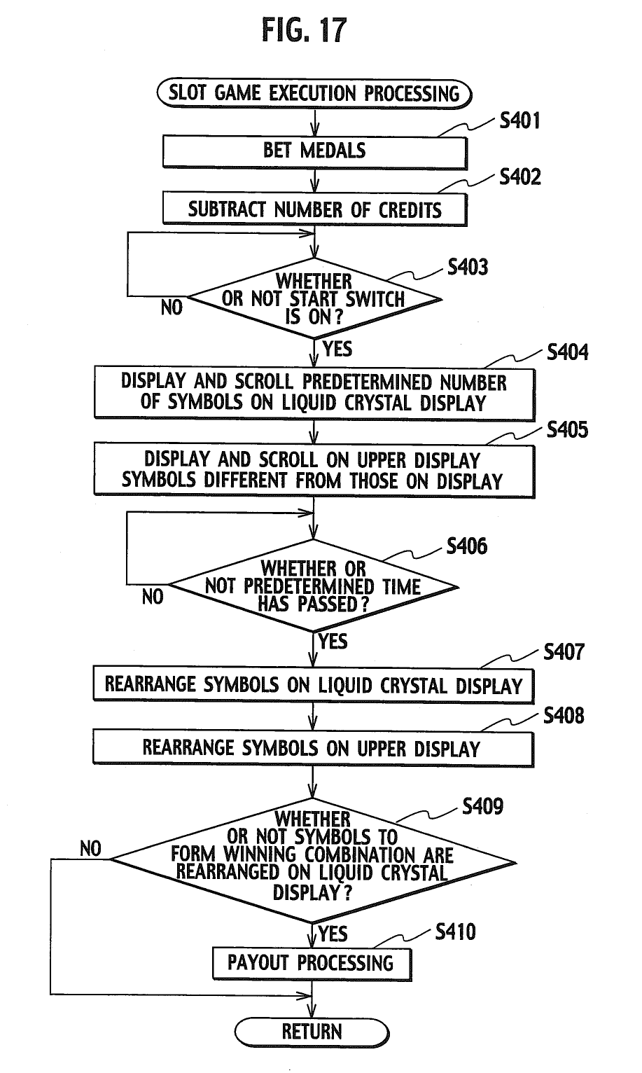

Next, with reference to a flowchart shown in FIG. 17, description will be given of slot game execution processing performed by the slot machine 10 according to the third modified embodiment of the present invention.

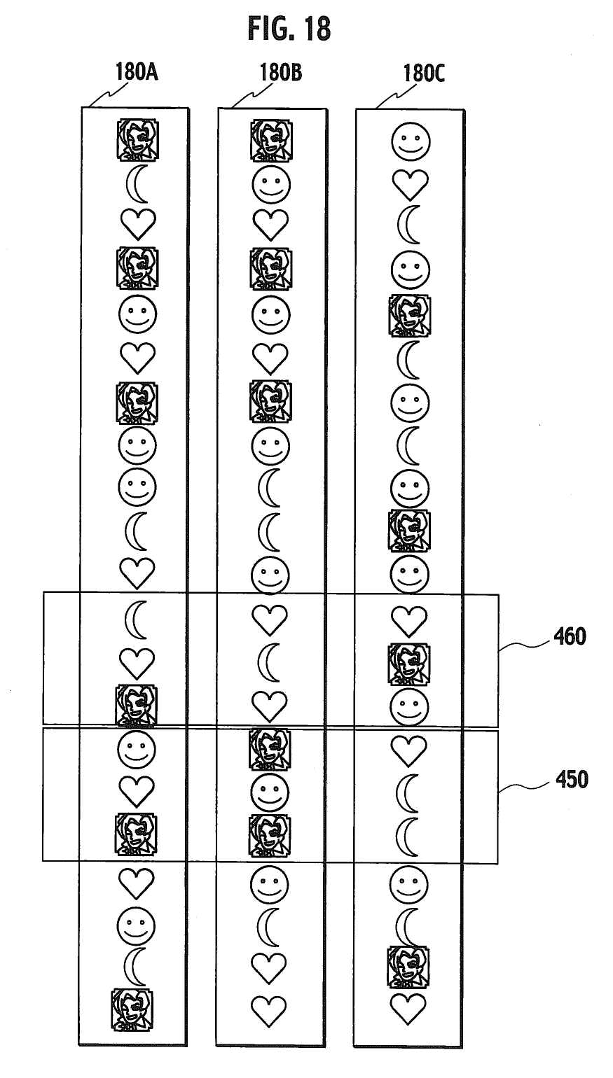

When medals are inserted into the medal insertion slot or a certain number of credits are bet by the player to execute a slot game (Step S401), the certain number of bet credits is subtracted from the number of credits currently held (Step S402). In this event, the number of credits bet is stored in the bet information storage area 110B in the RAM 110 and the number of credits from which the number of credits bet is subtracted is stored in the credit information storage area 110A. Thereafter, it is determined whether or not the start switch 27 is turned on. If the start switch 27 is turned on (YES in Step S403), symbols arranged in each of the symbol array display areas P31, P32 and P33 set in the first display area S31 on the liquid crystal display 16 are scrolled (Step S404). In this event, the CPU 106 displays the symbol group stored in the first symbol array storage area 108A in the ROM 108 by scrolling the symbol group in a predetermined direction in the first symbol array display area P31 in the first display area S31. Moreover, the CPU 106 displays the symbol group stored in the second symbol array storage area 108B by scrolling the symbol group in the predetermined direction in the second symbol array display area P32. Furthermore, the CPU 106 displays the symbol group stored in the third symbol array storage area 108C by scrolling the symbol group in the predetermined direction in the third symbol array display area P33. In this modified embodiment, as shown in FIG. 18, in a symbol group 450 displayed in the first display area S31 at a certain point in the scrolling, three symbols are displayed per array for each of the three symbol arrays. Thus, a total of nine symbols are displayed.

Furthermore, symbols arranged in each of the symbol display areas Q41, Q42 and Q43 set in the second display area S42 on the upper display 33 are scrolled (Step S405). In this event, the CPU 106 displays symbols provided adjacent to the symbols displayed in the first display area S31, while scrolling the symbols in a predetermined direction in the first symbol array display area Q41 in the second display area S42. Specifically, the CPU 106 displays the symbols including the symbols displayed in the first display area S31 and more from among the symbol groups stored in the first symbol array storage area 108A in the ROM 108.

Moreover, the CPU 106 displays symbols provided adjacent to the symbols displayed in the first display area S31 while scrolling the symbols in a predetermined direction in the first symbol array display area Q42 in the second display area S42. Specifically, the CPU 106 displays the symbols including the symbols displayed in the first display area S31 and more from among the symbol groups stored in the first symbol array storage area 108B in the ROM 108. Furthermore, the CPU 106 displays symbols provided adjacent to the symbols displayed in the first display area S31 while scrolling the symbols in a predetermined direction in the first symbol array display area Q43 in the second display area S42. Specifically, the CPU 106 displays the symbols including the symbols displayed in the first display area S31 and more from among the symbol groups stored in the first symbol array storage area 108C in the ROM 108 In this embodiment, as shown in FIG. 18, in a symbol group 460 displayed in the second display area S42 at a certain point in the scrolling, three symbols are displayed per array for each of the three symbol arrays. Thus, a total of nine symbols are displayed. The symbol group 460 displayed in the second display area S42 includes symbols adjacent to the symbol group 450 displayed in the first display area S31. Furthermore, in this event, when predetermined symbols are scrolled, the CPU 106 lights markers corresponding to the predetermined symbols in the second display area S42. Furthermore, in this event, the CPU 106 lights the markers corresponding to the predetermined symbols along with scrolling of the predetermined symbols.

Subsequently, when a predetermined time (for example, 5 seconds) has passed since start of symbol scrolling (YES in Step S406), the CPU 106 rearranges the symbols in the symbol array display areas P31, P32 and P33 in the first display area S31 (Step S407). Furthermore, the CPU 106 rearranges the symbols in the symbol array display areas Q41, Q42 and Q43 in the second display area S42 (Step S408). In this event, the symbols rearranged in the second display area S42 are symbols adjacently provided on an upstream side of the symbols rearranged in the first display area S31.

Based on the information on the winning combinations stored in the winning combination symbol storage area 108C in the ROM 108, the CPU 106 determines whether or not the symbols to form a winning combination are rearranged in each of the symbol array display areas P31, P32 and P33 in the first display area S31 (Step S409).

If the symbols to form a winning combination are rearranged in each of the symbol array display areas P31, P32 and P33 in the first display area S31 (YES in Step S409), the CPU 106 provides a payout (an award) corresponding to the winning combination based on the information stored in the payout credit storage area 108E in the ROM 108 and the bet information storage area 110A in the RAM 110 (Step S410). Moreover, if the symbols to form a winning combination are not rearranged in each of the symbol array display areas P31, P32 and P33 in the first display area S31 (NO in Step S409), the CPU 106 provides no payout. Accordingly, one slot game is finished and the processing returns to Step S401.

In the slot machine according to the third modified embodiment as described above, the symbols are displayed in the first display area S31 on the liquid crystal display 16 in which used to determine whether or not a winning combination is formed and symbols adjacently provided upstream of the symbols displayed in the first display area S31 are displayed in the second display area S42 on the upper display 33 in which not used to determine whether or not a winning combination is formed. Thus, it becomes easier to set timing for stopping desired symbols at desired positions. Consequently, it becomes easier for a user to stop symbols in a combination of symbols to form a winning combination.

Furthermore, in this modified embodiment, markers corresponding to specific symbols are moved along with scrolling of the symbols in the second display area S42. Thus, it becomes easier to set timing for stopping the specific symbols at desired positions.

### Other Modified Embodiments

Although the slot machine and the method for controlling a slot machine according to the present invention have been described above based on the embodiments shown in the drawings, the present invention is not limited thereto. The configurations of each of the parts can be replaced by arbitrary configurations having similar functions.

For example, in the above embodiments, the description was given of the example where the display area for displaying 3 rows×3 columns, a total of 9 symbols is provided on the liquid crystal display 16 and the slot game is executed in the display area. However, the present invention is not limited to the above example.

### INDUSTRIAL APPLICABILITY

The present invention is very effective in enhancing the player's motivation to play games.

What is claimed is:

1. A slot machine comprising:
a display configured to display a slot game in which a plurality of symbol arrays each having a predetermined number of symbols consecutively provided therein are scrolled in a loop manner and then stopped,
the display including:
a first display area for displaying some of the predetermined number of symbols included in each of the symbol arrays when the scrolling is stopped, and
a second display area for displaying the symbols displayed in the first display area and some additional symbols among the predetermined number of symbols included in each of the symbol arrays; and
a controller operable to:
a) execute the slot game on the display and
b) provide an award according to a combination of the symbols displayed in the first display area when the scrolling is stopped, regardless of the symbols displayed in the second display area.

2. The slot machine according to claim 1, wherein
the controller further displays markers indicating positions of specific symbols scrolled in the second display area, while each of the symbol arrays is scrolled.

3. The slot machine according to claim 1, wherein
the second display area is set so as to display the symbols displayed in the first display area and the symbols upstream, in a scrolling direction, of the symbols displayed in the first display area.

4. A slot machine comprising:
a display configured to display a slot game in which a plurality of symbol arrays each having a predetermined number of symbols consecutively provided therein are scrolled in a loop manner and then stopped,
the display including:
a first display area for displaying some of the predetermined number of symbols included in each of the symbol arrays when the scrolling is stopped, and
a second display area for displaying some symbols different from those displayed in the first display area among the predetermined number of symbols included in each of the symbol arrays; and
a controller operable to:
a) execute the slot game on the display, and
b) provide an award according to a combination of the symbols displayed in the first display area when the scrolling is stopped, regardless of the symbols displayed in the second display area.

5. The slot machine according to claim 4, wherein
the controller further displays markers indicating positions of specific symbols scrolled in the second display area, while each of the symbol arrays is scrolled.

6. The slot machine according to claim 4, wherein
the second display area is set so as to display the symbols upstream, in a scrolling direction, of the symbols displayed in the first display area.

7. A slot machine comprising:
first and second displays configured to display a slot game in which a plurality of symbol arrays each having a predetermined number of symbols consecutively provided therein are scrolled in a loop manner and then stopped; and
a controller operable to:
a) execute the slot game on the first and second displays and
b) provide an award according to a combination of the symbols displayed on the first display when the scrolling is stopped, regardless of the symbols displayed on the second display,
wherein the first display displays some of the predetermined number of symbols included in each of the symbol arrays when the scrolling is stopped, and
the second display displays at least some of the symbols not displayed on the first display among the predetermined number of symbols included in each of the symbol arrays.

8. The slot machine according to claim 7, wherein
the controller further displays markers indicating positions of specific symbols scrolled on the second display, while each of the symbol arrays is scrolled.

9. The slot machine according to claim 7, wherein
the second display is set so as to display the symbols upstream, in a scrolling direction, of the symbols displayed on the first display.

10. A method for controlling a slot machine, comprising:
a) displaying, in a first display area of a display configured to display a slot game in which a plurality of symbol arrays each having a predetermined number of symbols consecutively provided therein are scrolled in a loop manner and then stopped, some of the predetermined number of symbols included in each of the symbol arrays when the scrolling is stopped;
b) displaying, in a second display area of the display the symbols displayed in the first display area and some additional symbols among the predetermined number of symbols included in each of the symbol arrays; and
c) executing the slot game on the display and providing an award according to a combination of the symbols displayed in the first display area when the scrolling is stopped, regardless of the symbols displayed in the second display area.

11. The method for controlling a slot machine, according to claim 10, further comprising:
displaying markers indicating positions of specific symbols scrolled in the second display area, while each of the symbol arrays is scrolled.

12. The method for controlling a slot machine, according to claim 10, wherein
the second display area is set so as to display the symbols displayed in the first display area and the symbols upstream, in a scrolling direction, of the symbols displayed in the first display area.

13. A method for controlling a slot machine, comprising:
a) displaying, in a first display area of a display which configured to display a slot game in which a plurality of symbol arrays each having a predetermined number of symbols consecutively provided therein are scrolled in a loop manner and then stopped, some of the predetermined number of symbols included in each of the symbol arrays when the scrolling is stopped;
b) displaying, in a second display area of the display, some symbols different from those displayed in the first display area among the predetermined number of symbols included in each of the symbol arrays; and
c) executing the slot game on the display and providing an award according to a combination of the symbols displayed in the first display area when the scrolling is stopped, regardless of the symbols displayed in the second display area.

14. The method for controlling a slot machine, according to claim 13, further comprising:
displaying markers indicating positions of specific symbols scrolled in the second display area, while each of the symbol arrays is scrolled.

15. The method for controlling a slot machine, according to claim 13, wherein
the second display area is set so as to display the symbols upstream, in a scrolling direction, of the symbols displayed in the first display area.

16. A method for controlling a slot machine, comprising:
a) displaying, on a first display configured to display a slot game in which a plurality of symbol arrays each having a predetermined number of symbols consecutively provided therein are scrolled in a loop manner and then stopped, some of the predetermined number of symbols included in the respective symbol arrays when the scrolling is stopped;
b) displaying, on a second display configured to display the slot game in which the plurality of symbol arrays each having the predetermined number of symbols consecutively provided therein are scrolled in a loop manner and then stopped, at least some of the symbols not displayed on the first display among the predetermined number of symbols included in the respective symbol arrays; and
c) executing the slot game on the first and second displays and providing an award according to a combination of the symbols displayed on the first display when the scrolling is stopped, regardless of the symbols displayed on the second display.

17. The method for controlling a slot machine, according to claim 16, further comprising:
displaying markers indicating positions of specific symbols scrolled on the second display, while each of the symbol arrays is scrolled.

18. The method for controlling a slot machine, according to claim 16, wherein
the second display is set so as to display the symbols upstream, in a scrolling direction, of the symbols displayed on the first display.
